(19) United States
(12) Patent Application Publication
(10) Pub. No.: US 2005/0076017 A1
(43) Pub. Date: Apr. 7, 2005

(54) Method and system for scheduling search terms in a search engine account

(76) Inventors: Douglas R. Rein, Williamsville, NY (US); Douglas J. Hagen, Lockport, NY (US)

Correspondence Address: HODGSON RUSS LLP, ONE M & T PLAZA, SUITE 2000, BUFFALO, NY, 14203-2391, US

(21) Appl. No.: 10/679,091

(22) Filed: Oct. 3, 2003

(51) Int. Cl. G06F 7/00

(52) U.S. Cl. 707/3

(57) ABSTRACT

A method and system enable Internet advertisers to automatically activate and deactivate search terms or groups of search terms in a search engine account at scheduled times to improve return on investment. The method and system also allow for immediate, non-scheduled activation and deactivation of a search term as a further account management tool.

### FIELD OF THE INVENTION

The present invention relates generally to Internet search engines, and more particularly to a method and system enabling more effective management of advertiser search terms in a search engine account.

### BACKGROUND OF THE INVENTION

The transfer of information over computer networks has become an increasingly important means by which institutions, corporations, and individuals do business. Computer networks have grown over the years from independent and isolated entities established to serve the needs of a single group into vast internets which interconnect disparate physical networks and allow them to function as a coordinated system. Currently, the largest computer network in existence is the Internet. The Internet is a worldwide interconnection of computer networks that communicate using a common protocol. Millions of computers, from low end personal computers to high end super computers, are connected to the Internet.

The Internet has emerged as a large community of electronically connected users located around the world who readily and regularly exchange information. The Internet continues to serve its original purposes of providing access to and exchange of information among government agencies, laboratories, and universities for research and education. In addition, the Internet has rapidly become a global electronic marketplace of goods and services. This transformation of the Internet into a global marketplace was driven in large part by the introduction of an information system known as the World Wide Web (“the web”). The web is a unique distributed database designed to give wide access to a large universe of documents. The database records of the web are in the form of documents known as “pages”. These pages reside on web servers and are accessible via the Internet. The web is therefore a vast database of information dispersed across countless individual computer systems that is constantly changing and has no recognizable organization. Computers connected to the Internet may access the web pages via a program known as a browser, which typically has a graphical user interface. One powerful technique supported by web browsers is known as hyperlinking, which permits web page authors to create links to other web pages which users can then retrieve by using simple point-and-click commands on the web browser.

Web pages may be constructed in any one of a variety of formatting conventions, such as Hyper Text Markup Language (HTML), and may include multimedia information content such as graphics, audio, and moving pictures. Any person with a computer and a connection to the Internet may access any publicly accessible page posted on the web. Thus, a presence on the World Wide Web has the capability to introduce a worldwide base of consumers to businesses, individuals, and institutions seeking to advertise their products and services to potential customers. Furthermore, the ever increasing sophistication in the design of web pages, made possible by the exponential increase in data transmission rates and computer processing speeds, makes the web an increasingly attractive medium for advertising and other business purposes, as well as for the free flow of information.

The availability of powerful new tools that facilitate the development and distribution of Internet content has led to a proliferation of information, products, and services offered on the Internet and dramatic growth in the number of consumers using the Internet. As a result, directories and search engines have been developed to index and search the information available on the web and thereby help Internet users locate information of interest. These search services enable consumers to search the Internet for a listing of web sites or web pages based on a specific topic, product, or service of interest.

Search services are, after e-mail, the most frequently used tool on the Internet. As a result, web sites providing search services have offered advertisers significant reach into the Internet audience and have given advertisers the opportunity to target consumer interests based on keyword or topical search requests. In a web-based search on an Internet search engine, a user enters a search term comprising one or more keywords, which the search engine then uses to generate a listing of web pages that the user may access via a hyperlink. Many search engines and web site directories of the prior art rely upon processes for assigning results to keywords that often generate irrelevant search results. The automated search technology that drives many search engines in the prior art implements complex database search algorithms that select and rank web pages based on multiple criteria such as keyword density and keyword location. In addition, search engines that use automated search technology to catalog search results generally rely on invisible web site descriptions, or “meta tags”, that are authored by web site promoters. Web site owners may freely tag their sites as they choose. Consequently, some web site promoters insert popular search terms into their web site meta tags that are not relevant to the web site, because by doing so they may attract additional consumer attention at little to no marginal cost. Finally, many different web sites can have similar meta tags, and search engines of the type described above are simply not equipped to prioritize results in accordance with consumers' preferences.

Existing search engines and web site directories may also rely on the manual efforts of limited editorial staffs to review web page information. Because comprehensive manual review and indexing of an unpredictable, randomly updated database such as the web is an impossible task, search engine results are often incomplete or out-of-date. Moreover, as the volume and diversity of Internet content has grown, on many popular web search sites, consumers must frequently click-through multiple branches of a hierarchical directory to locate web sites responsive to their search request, a process that is slow and unwieldy from the consumer's standpoint.

Furthermore, the use of banner advertising for generating web site traffic follows traditional advertising approaches and fails to utilize the unique attributes of the Internet. In the banner advertising model, web site promoters seeking to promote and increase their web exposure often purchase space on the pages of popular commercial web sites. The web site promoters usually fill this space with a colorful graphic, known as a banner, advertising their own web site. The banner may act as a hyperlink to the promoter's site. Like traditional advertising, banner advertising on the Internet is typically priced on an impression basis with advertisers paying for exposures to potential consumers. Banners may be displayed at every page access, or, on search engines, may be targeted to search terms. Nonetheless, impression-based advertising inefficiently exploits the Internet's direct marketing potential, as the click-through rate, the rate of consumer visits a banner generates to the promoter's web site, may be quite low. Web site promoters are therefore paying for exposure to many consumers who are not interested in the product or service being promoted, as most visitors to a web site seek specific information and may not be interested in the information announced in the banner. Likewise, the banner often fails to reach interested individuals, since the banner is not generally searchable by search engines and the interested persons may not know where on the web to view the banner.

One approach that has emerged to help web page owners target their web exposure and distribute information to the attention of interested users on a current and comprehensive basis is the “bid-for-position” search engine (also known as “bid-for-location” and “pay-per-click” search engine). Under this approach, web page owners or promoters maintain an account with the bid-for-position search engine and register respective competitive bid amounts on keywords related to web page or web site content. Search results are returned by the bid-for-position search engine in an order determined by the competitive bids, with the web site of the high bidder for the searched keyword being listed first and so on. Accordingly, under the bid-for-position model, web site promoters can control the placement of their web site link in search result listings so that their link is prominent in searches that are relevant to the content of their web site. Because advertisers and promoters must pay for each click-through referral coming from the search result listing generated by the bid-for-position search engine, they have an incentive to select and bid on those search keywords that are most relevant to their web site offerings and content. The higher an advertiser's position on a search result list, the higher likelihood of a “referral”; that is, the higher the likelihood that a consumer will be referred to the advertiser's web site through the search result list. The openness of this advertising marketplace is further facilitated by publicly displaying, to consumers and other advertisers, the price bid by an advertiser on a particular search result listing.

While search engines are successful at directing qualified customers to commercial web sites, advertisers have recognized that the average amount spent by a consumer clicking through to a commercial web site varies with the time of day, day of the week, week of the month, and even month of the year. For example, internet gaming sites may observe higher average spending during nighttime hours on any day of the week; office supply sites likely find higher average spending from 9:00 AM to 5:00 PM Mondays through Fridays; on-line truck rental sites may see increased spending per click through near the end of the month; and sites specializing in seasonal items may see changes in spending behavior based on time of year. Advertisers can easily collect spending data to track fluctuations in average spending as a function of time and date. However, to this point, advertisers have not been able to easily put this information to use to maximize return on investment (ROI) with respect to advertising expenditures (i.e. bid amounts and search terms). Consequently, there is a need for a method and system that will allow advertisers greater control over when a particular search term (and associated bid amount) are active.

### SUMMARY OF THE INVENTION

Therefore, it is an object of the present invention to provide a method and system for scheduling individual search terms in an advertiser's account for intermittent use during times when an advertiser deems it worthwhile, and for automatically activating and deactivating the search term in accordance with the schedule.

It is another object of the present invention to provide a method and system for scheduling user-created groups of search terms in an advertiser's account for intermittent use during times when an advertiser deems it worthwhile, and for automatically activating and deactivating search terms in a group in accordance with the schedule.

It is another object of the present invention to provide a method and system that allows an advertiser to immediately activate and deactivate a particular search term over the Internet.

In furtherance of these and other objects, a method for scheduling a search term in a search engine advertiser account for intermittent use by a search engine is provided. The method generally comprises the steps of: (A) receiving a user instruction indicating at least one activated period when the search term is to be included in a database searched by the search engine and at least one deactivated period when said search term is to be excluded from the database, and (B) including the search term in the database during the activated period(s) and excluding the search term from said database during the deactivated period(s). The instruction is generated by the advertiser from a scheduling form accessible through a secure account management web page, wherein the advertiser enters scheduling data defining the activated period(s) and deactivated period(s). Preferably, the scheduling form includes a graphic schedule indicating when the search term is scheduled to be activated and when it is scheduled to be deactivated.

In another embodiment of the present invention, an advertiser can “manually” control search term activation. A method according to this embodiment generally comprises the steps of (A) receiving a user instruction indicating that the activation status of the search term should be immediately changed from its current status to an opposite status, and (B) including the search term in the database, or excluding the search term from the database, in accordance with the user instruction. A command button is provided on the secure account management web page, which button the advertiser clicks to generate the instruction.

The present invention also encompasses a method for scheduling a plurality of search terms in a search engine advertiser account for intermittent use by a search engine, wherein the search terms are grouped together and share a common group identifier. For example, search terms may be grouped by subject matter, i.e. “bike stuff”, and this group can be scheduled based on the on-line buying behavior of the associated demographic.

The present invention also encompasses a computer system for implementing the methods as summarized above.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram of a computer network system embodying the present invention;

FIG. 2 is a screen capture showing a secure account web page corresponding to a search engine advertiser account through which search terms in the advertiser account are managed;

FIG. 3 shows a summary sheet associated with the account web page of FIG. 2, the summary sheet listing individually scheduled search terms;

FIG. 4 shows a scheduling data tab of a scheduling form of the present invention associated with the account web page of FIG. 2, wherein the scheduling form is accessed to add scheduling to selected search terms;

FIG. 5 is a view similar to that of FIG. 4, wherein the scheduling form is already linked to a specific search term;

FIG. 6 shows a search term selection tab of the scheduling form of FIG. 5;

FIG. 7 shows a summary sheet associated with the account web page of FIG. 2, the summary sheet listing scheduled search term groups;

FIG. 8 shows a scheduling data tab of a scheduling form of the present invention associated with the account web page of FIG. 2, wherein the scheduling form is linked to a selected group of search terms;

FIG. 9 shows a search term selection tab of the scheduling form of FIG. 8;

FIG. 10 is a schematic diagram depicting tables and relationships for implementing the scheduling method and system of the present invention;

FIG. 11 is a schematic flow diagram of a programming routine for monitoring time and date, and implementing an activate/deactivate routine at hourly intervals;

FIG. 12 is a schematic flow diagram of the activate/deactivate routine referenced in FIG. 11;

FIG. 13 is a screen capture showing a secure account web page corresponding to a search engine advertiser account through which search terms in the advertiser account are managed, and a summary table associated therewith, in accordance with another embodiment of the present invention; and

FIG. 14 shows a search term scheduling form associated with the account web page of FIG. 13.

### DETAILED DESCRIPTION OF THE INVENTION

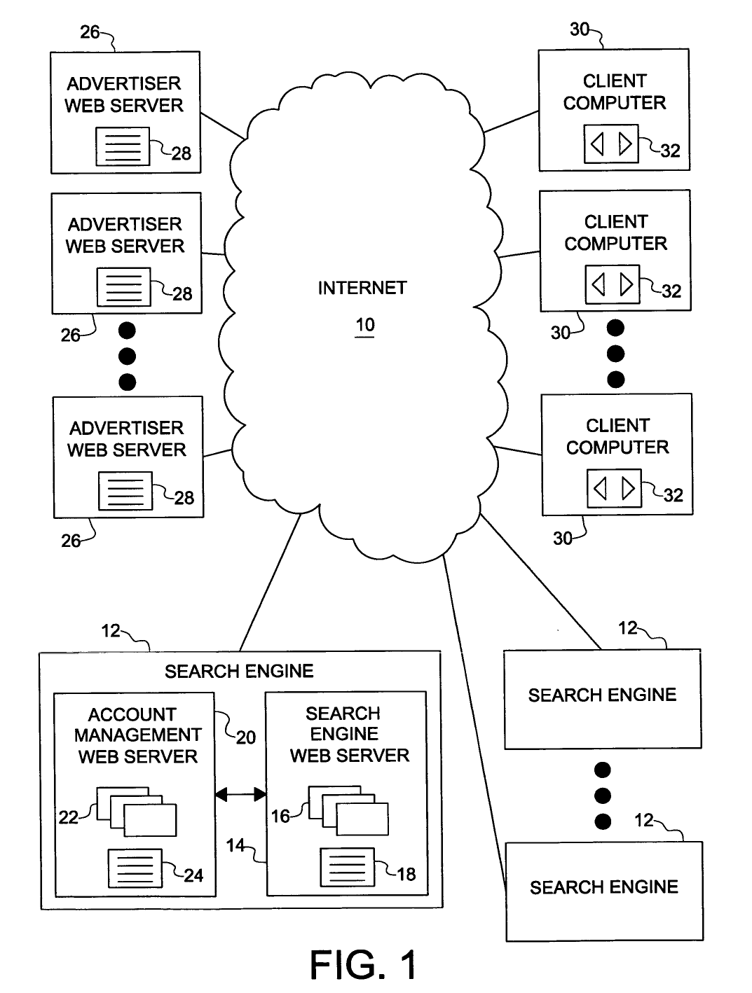

As used in the specification and drawings, the terms “keyword” and “search term” are interchangeable. Referring initially to FIG. 1 of the drawings, a computer network system is shown schematically as including a plurality of search engines 12, a plurality of advertiser web servers 26, and a plurality of client computers 30, all of which are interconnected through the Internet 10. A primary search engine 12 is shown in detail as having a search engine web server 14 and an account management web server 20 connected to the search engine web server to exchange information therewith. Search engine web server 14 stores a search engine database 16 and programming for generating a search engine web page 18 on which search results are displayed. Account management web server 20 stores an accounts database 22 and programming for generating a secure account management web page 24. Each advertiser web server 26 stores programming for generating an advertiser web page 28 that promotes or offers goods or services, or provides other information which can be accessed by members of the public using client computers 30 connected to Internet 10 and having executable browser software 32 stored thereon. As will be appreciated, advertisers promoting web pages 28 have accounts with one or more search engines 12, and members of the public using client computers 30 may visit the search engine web page 18 or an affiliate web page to run a keyword search that returns a list of matching links to various web pages 28 from search engine database 16.

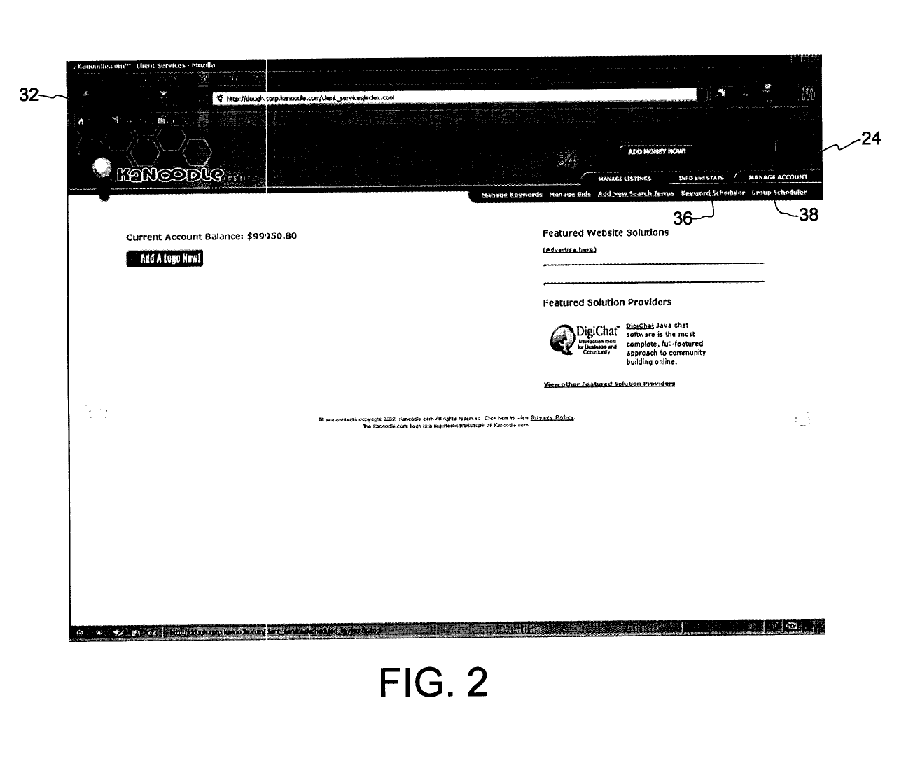

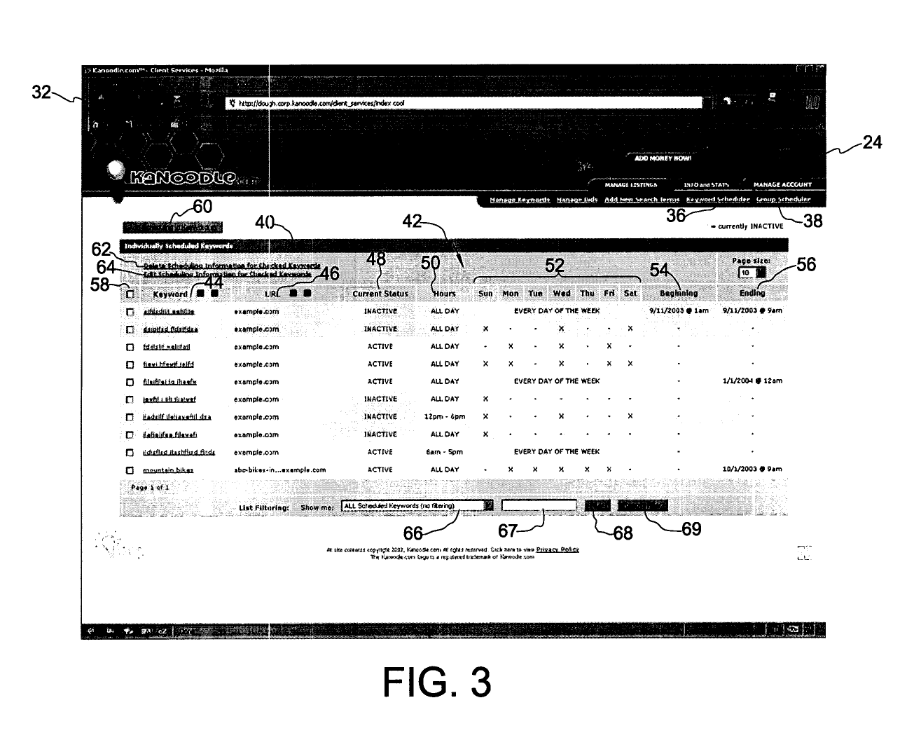

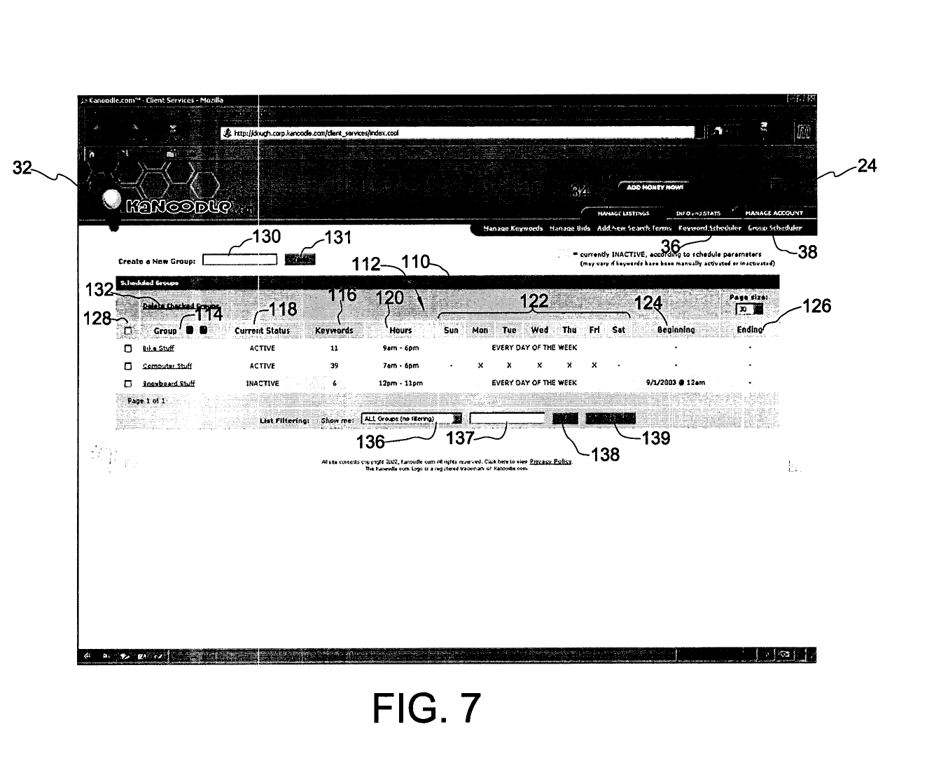

Attention is directed now to FIGS. 2-6. FIG. 2 shows account management web page 24, which is accessed using browser 32, in detail. For purposes of the present description, search engine 12 is a bid-for-position search engine, however the present invention is not confined to a bid-for-position search engine model and can be applied to other search engine models. Account management web page 24 includes a “MANAGE LISTINGS” tab 34 having various sub-tabs including a “Keyword Scheduler” sub-tab 36 and a “Group Scheduler” sub-tab 38. When “Keyword Scheduler” sub-tab 36 is clicked by a user, a summary sheet 40 listing individually scheduled search terms is displayed on web page 24 as shown in FIG. 3. When “Group Scheduler” sub-tab 38 is clicked by a user, a summary sheet 110 listing scheduled search term groups is displayed on web page 24, as will be described below in connection with FIG. 7. As mentioned in the background, an advertiser may have strategic reasons for activating and deactivating a search term at various times. More specifically, advertisers will strive to maximize their return on investment (ROI) by focusing on qualified leads. For some products, such as office and business supplies, consumers who click through during daytime hours are more qualified and likely to buy than consumers clicking through during evening or non-business hours. For other products, such as music CDs and entertainment DVDs, persons clicking through during evening hours are more likely to make a purchase than persons clicking through during daytime business hours. The present invention enables advertisers to activate search terms at times when the most qualified consumers click through and sales per click through are highest, on average, and to deactivate search terms when sales per click through do not justify paying the bid amount.

Summary sheet 40 in FIG. 3 includes a summary table 42 listing scheduling and other management information for each individually scheduled search term. Table 42 includes a keyword field 44 listing the specific search term as a hyperlink, a URL field 46 indicating the URL associated with the search term, a current status field 48 showing whether the corresponding search term is active or inactive, an hours field 50 showing the hours of the day during which the search term is scheduled to be active, day-of-the-week fields 52 showing the days of the week during which the search term is scheduled to be active, beginning field 54 indicating the date and time when the corresponding scheduling data are first applicable, and an ending field 56 indicating the date and time when the corresponding scheduling data are no longer applicable. A check box field 58 is provided to enable a user to select specific search terms to which further actions apply. For example, the user may click an “Add Scheduling to Keyword(s)” command button 60, a “Delete Scheduling Information for Checked Keywords” label 62, or an “Edit Scheduling Information for Checked Keywords” label 64 to execute these actions only with respect to checked search terms. The user may filter the search terms listed in table 42 by selecting a predetermined filter using the drop-down menu of combo box 66 and supplying optional filter criteria in text box 67, and then clicking a “Filter” command button 68. An applied filter can be removed by clicking a “Remove Filter” command button 69.

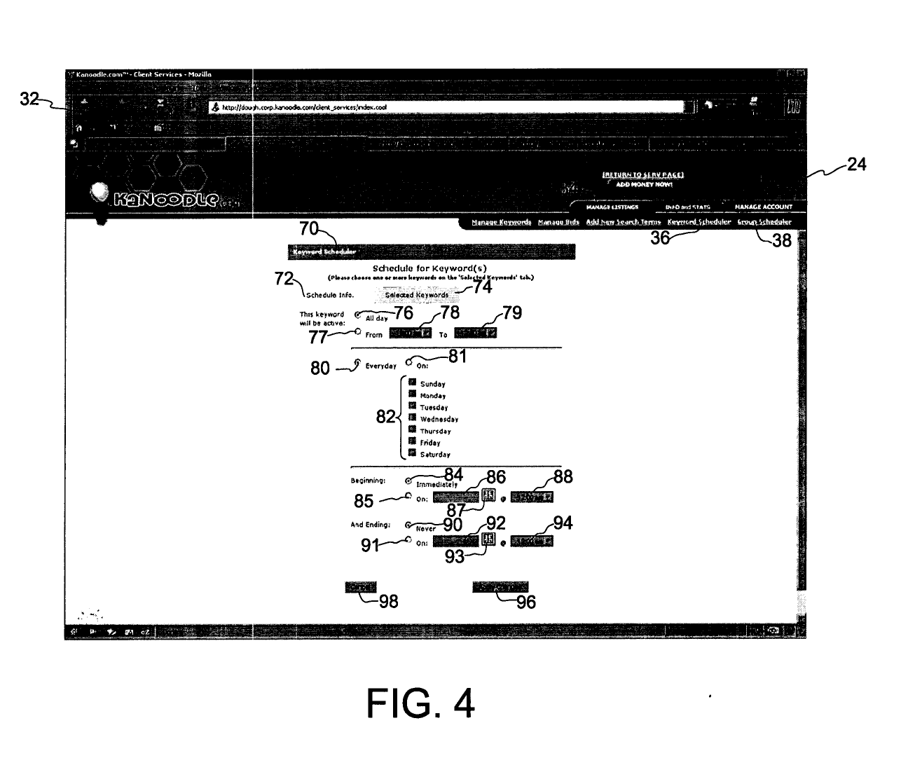

As mentioned above, a user can add scheduling information for selected search terms by clicking command button 60. FIG. 4 shows a scheduling form 70 that is displayed when command button 60 is clicked. Scheduling form 70 includes a “Schedule Info.” tab 72 for entry of scheduling data, and a “Selected Keywords” tab 74 for control of the search terms to which the scheduling data apply. “Schedule Info.” tab 72 provides an interface enabling a user to input a time of day, day(s) of the week, and a date range for defining at least one activated period when the selected search term(s) is to be included in the search engine database (in other words, the search term will be active) and at least one deactivated period when the selected search term(s) is to be excluded from the search engine database (in other words, the search term will be inactive). The scheduling interface includes a pair of option buttons 76 and 77, only one of which can be selected at a given time. When option button 76 is selected, the search term will be active all day; when option button 77 is selected, the user can enter a starting time in combo box 78 and an ending time in combo box 79 to indicate a time period during the day when the search term is to be active. Combo boxes 78 and 79 provide drop-down menus that limit the times entered to times that are on the hour, i.e. 3:00 pm, 4:00 pm, etc. The scheduling interface includes another pair of option buttons 80 and 81, only one of which can be selected at a given time. When option button 80 is selected, the search term will be active every day of the week during the indicated time of day; when option button 81 is selected, the user can check one or more day-of-the-week check boxes 82 to chose the days of the week when the search term will be active during the indicated time of day. Finally, the scheduling interface includes a pair of option buttons 84 and 85 provided in connection with inputting a beginning date and time, and another pair of option buttons 90 and 91 provided in connection with inputting an ending date and time. When option button 84 is selected, the beginning date and time will be the current date at 12:00 am; when option button 85 is selected, the user can enter a beginning date in text box 86 with the optional help of a calendar control 87 and a beginning time on that date by means of combo-box 88. To set the ending date and time, the user can select either option button 90 to keep the scheduling data in effect indefinitely, or option button 91 to set a specified ending date and time. If option button 91 is checked, the user can enter an ending date in text box 92 with the optional help of a calendar control 93 and an ending time on that date by means of combo-box 94. The user has the option of applying the entered scheduling data by clicking an “Apply Changes” command button 96, or canceling by clicking a “Cancel” command button 98.

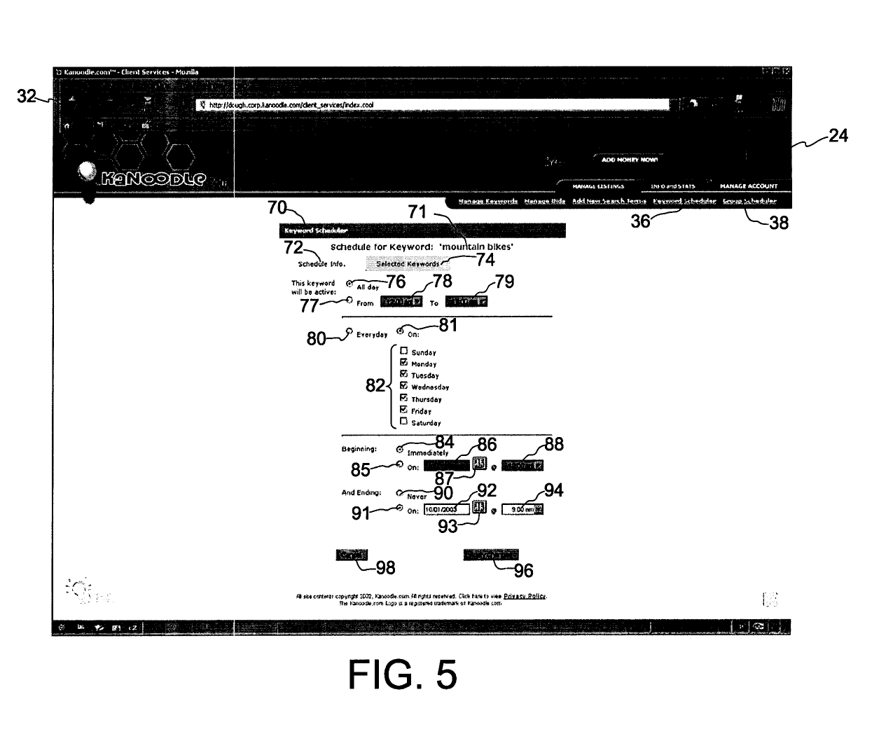

FIG. 5 is a view similar to FIG. 4, but shows scheduling form 70 as it appears when a specific search term hyperlink, namely “mountain bikes”, is clicked from table 42 in FIG. 3. Scheduling form 70 preferably includes a label 71 indicating the search term to which the scheduling data apply. As can be seen, the search term “mountain bikes” is scheduled to be active all day, Monday through Friday, through Oct. 1, 2003 at 9:00 am. The applied scheduling data are represented in table 42 of FIG. 3.

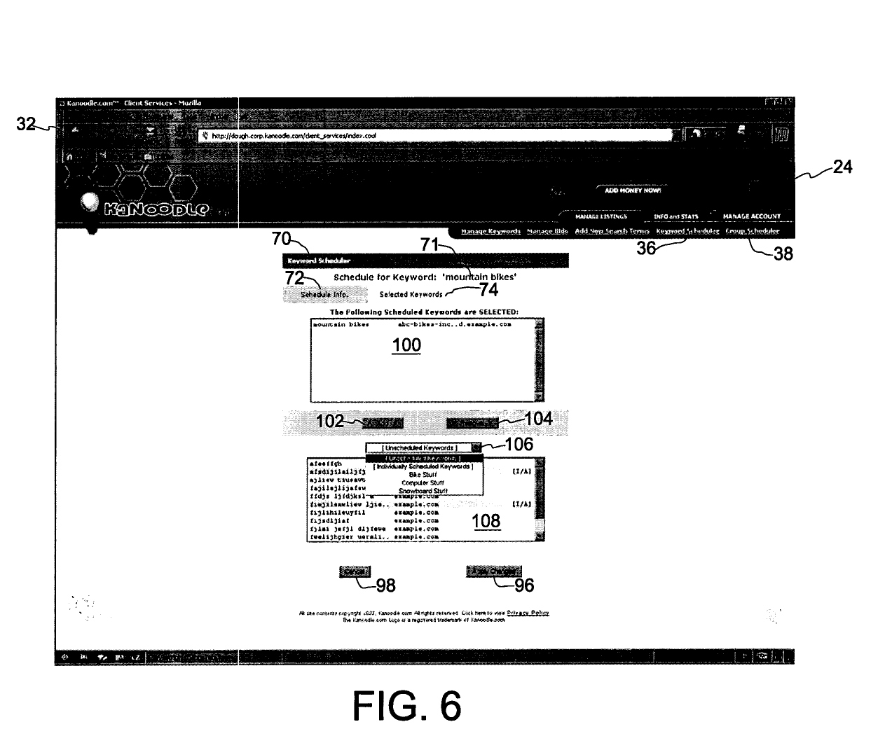

FIG. 6 shows an interface displayed under the “Selected Keywords” tab 74. A top list box 100 contains a list of the selected search terms, while a bottom list box 108 contains a list of search terms that are not selected. The user can control the search terms listed in bottom list box 108 by selecting a menu option presented by a combo box 106 just above bottom list box 108. The menu options preferably include [Unscheduled Keywords] for listing all search terms that are not in the scheduling system at all, [Individually Scheduled Keywords] for listing search terms that are scheduled on an individual basis, and group names for listing search terms belonging to a user-defined group. A search term can only exist in one of the menu options at a given time; a search term cannot belong to two or more groups, or be scheduled on an individual basis when it belongs to a group. The user can move search terms between top list box 100 and bottom list box 108 by clicking an “Add” command button 102 or a “Remove” command button 104.

As mentioned above, clicking “Group Scheduler” sub-tab 38 on account management web page 24 causes a group summary sheet 110 to be displayed as shown for example in FIG. 7. Group summary sheet 110 is generally similar to individual search term summary sheet 40 shown in FIG. 3, however it lists information relating to each defined group of search terms, as opposed to individual search terms. Summary sheet 110 includes a summary table 112 listing scheduling and other management information for each scheduled search term group. Table 112 includes a group field 114 listing the specific group name as a hyperlink, a keyword count field 116 indicating the number of search terms in the group, a current status field 118 showing whether the corresponding group is active or inactive, an hours field 120 showing the hours of the day during which the group is scheduled to be active, day-of-the-week fields 122 showing the days of the week during which the group is scheduled to be active, a beginning field 124 indicating the date and time when the corresponding scheduling data are first applicable, and an ending field 126 indicating the date and time when the corresponding scheduling data are no longer applicable. A check box field 128 is provided to enable a user to select specific groups to which further actions apply. For example, the user may click a “Delete Checked Groups” label 132 to execute this action only with respect to selected groups. Creation of a new group is carried out by entering a unique group name serving to identify the group in text box 130, and clicking a “Create” command button 131. The user may filter the search terms listed in table 112 by selecting a predetermined filter using the drop-down menu of combo box 136 and supplying optional filter criteria in text box 137, and then clicking a “Filter” command button 138. An applied filter can be removed by clicking a “Remove Filter” command button 139.

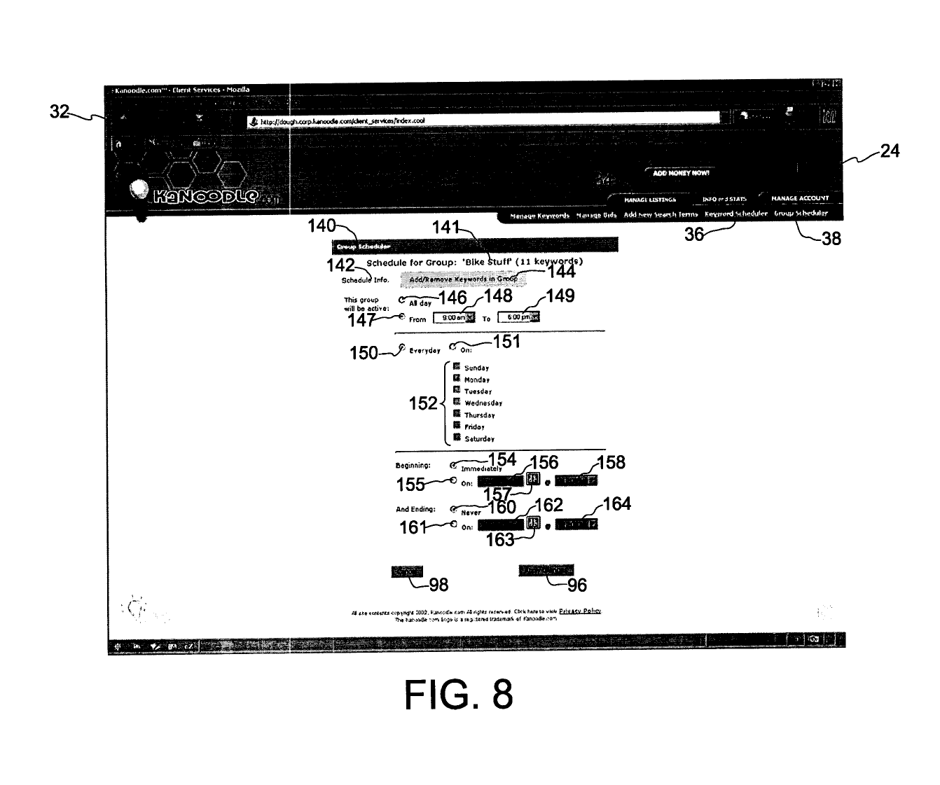

A user can display a group scheduling form 140 as illustrated in FIG. 8 by clicking a corresponding hyperlink on group summary sheet 110 shown in FIG. 7. For example, the user can click on “Bike Stuff” to display group scheduling form 140 for the group named “Bike Stuff”, wherein the selected group is preferably indicated by a label 141 on the group scheduling form. Group scheduling form 140 includes a “Schedule Info.” tab 142 that is identical in format to “Schedule Info.” tab 72 of individual scheduling form 70, and an “Add/Remove Keywords in Group” tab 144 that is similar to the “Selected Keywords” tab 74 of individual scheduling form 70. “Schedule Info.” tab 142 provides an interface enabling a user to input a time of day, day(s) of the week, and a date range for defining at least one activated period when the search terms in the corresponding group are to be active, and at least one deactivated period when the search terms in the corresponding group are to be inactive. The scheduling interface includes a pair of option buttons 146 and 147, only one of which can be selected at a given time. When option button 146 is selected, the search terms in the group will be active all day; when option button 147 is selected, the user can enter a starting time in combo box 148 and an ending time in combo box 149 to indicate a time period during the day when the search terms in the group are to be active. Combo boxes 148 and 149 provide drop-down menus that limit the times entered to times that are on the hour. The scheduling interface includes another pair of option buttons 150 and 151, only one of which can be selected at a given time. When option button 150 is selected, the search terms in the corresponding group will be active every day of the week during the indicated time of day; when option button 151 is selected, the user can check one or more day-of-the-week check boxes 152 to chose the days of the week when the search terms in the group will be active during the indicated time of day. Finally, the scheduling interface includes a pair of option buttons 154 and 155 provided in connection with inputting a beginning date and time, and another pair of option buttons 160 and 161 provided in connection with inputting an ending date and time. When option button 154 is selected, the beginning date and time will be the current date at 12:00 am; when option button 155 is selected, the user can enter a beginning date in text box 156 with the optional help of a calendar control 157 and a beginning time on that date by means of combo-box 158. To set the ending date and time, the user can select either option button 160 to keep the scheduling data in effect indefinitely, or option button 161 to set a specified ending date and time. If option button 161 is checked, the user can enter an ending date in text box 162 with the optional help of a calendar control 163 and an ending time on that date by means of combo-box 164. The user has the option of applying the entered scheduling data by clicking “Apply Changes” command button 96, or canceling by clicking “Cancel” command button 98.

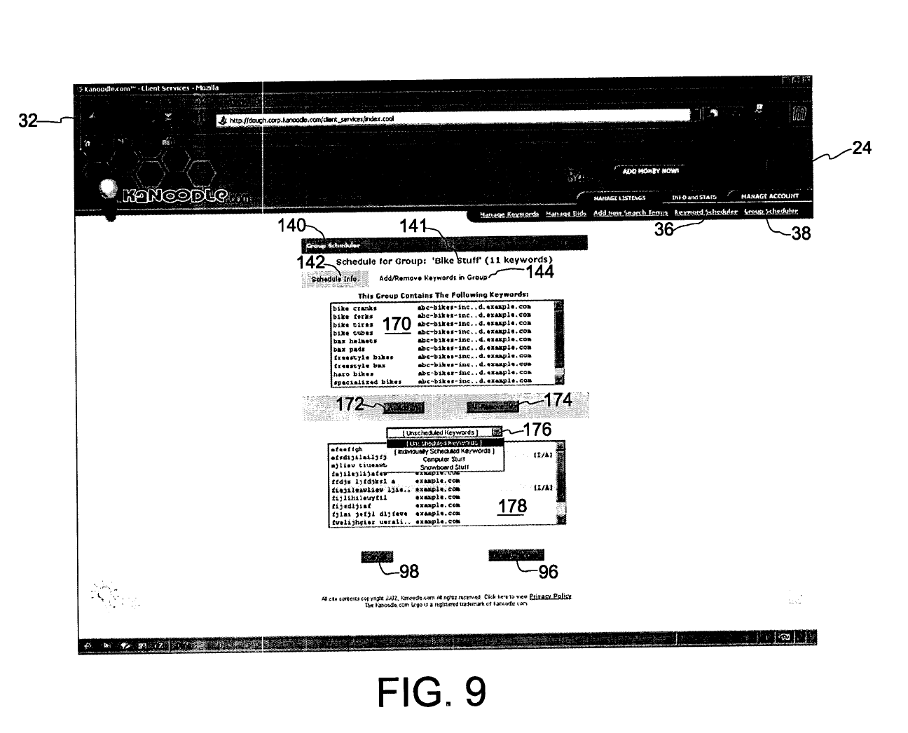

FIG. 9 shows an interface displayed under the “Add/Remove Keywords in Group” tab 144. A top list box 170 contains a list of search terms included in the corresponding group, while a bottom list box 178 contains a list of search terms that are not in the group. The user can control the search terms listed in bottom list box 178 by selecting a menu option presented by a combo box 176 just above bottom list box 178. The menu options preferably include [Unscheduled Keywords] for listing all search terms that are not in the scheduling system at all, [Individually Scheduled Keywords] for listing search terms that are scheduled on an individual basis, and group names for listing search terms belonging groups other than the corresponding group being scheduled. The user can move search terms between top list box 170 and bottom list box 178 by clicking an “Add” command button 172 or a “Remove” command button 174.

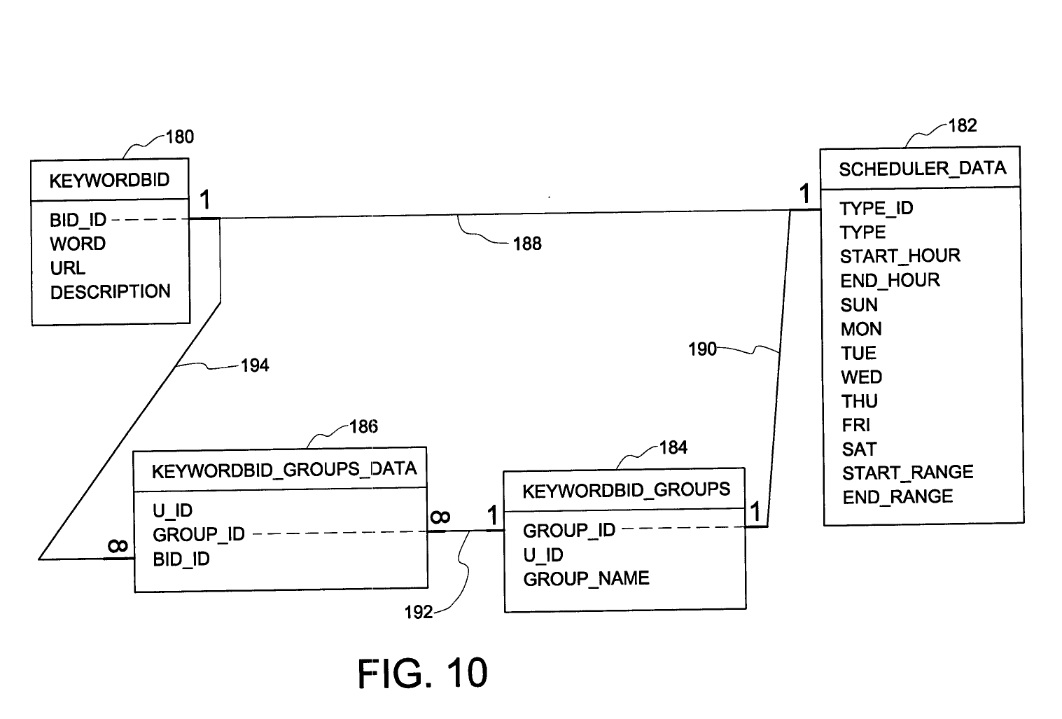

FIG. 10 is a schematic diagram showing underlying tables and relationships in account database 22 for storing search term, group, scheduling, and linking data. In the embodiments described herein, account database 22 can be created using any suitable database programming software. In the embodiment presently being described, four tables are instrumental: KEYWORDBID table 180, SCHEDULER_DATA table 182, KEYWORDBID_GROUPS table 184, and KEYWORDBID_GROUPS_DATA table 186. KEYWORDBID table 180 has fields for storing basic information pertaining to each search term, including a BID_ID field for storing a unique key (no two search terms have the same unique key). SCHEDULER_DATA table 182 has fields for storing data entered by the user through scheduling forms 70 and 140, as well as a TYPE_ID field containing a unique key and a TYPE field storing a value that is either “KEYWORD” or “GROUP” to indicate whether the corresponding scheduling data pertain to a search term or a group of search terms. KEYWORDBID_GROUPS table 184 stores basic information pertaining to user-created groups, and has a GROUP_ID unique key field. KEYWORDBID_GROUPS_DATA table 186 serves as a junction table between KEYWORDBID table 180 and KEYWORDBID_GROUPS table 184. If the value of the TYPE field in SCHEDULER_DATA table 182 is “KEYWORD”, then the corresponding scheduling data stored in other fields of the same record relate to an individual search term and the value of TYPE_ID corresponds to the value of BID_ID in KEYWORDBID table 180. If, however, the value of the TYPE field is “GROUP”, then the corresponding scheduling data relate to a group, and the value of TYPE_ID corresponds to the value of GROUP_ID in KEYWORDBID_GROUPS table 184. As can be understood from FIG. 10, there is a one-to-one relationship 188 between KEYWORDBID.BID_ID and SCHEDULER_DATA.TYPE_ID; there is a one-to-one relationship 190 between KEYWORDBID_GROUPS.GROUP_ID and SCHEDULER_DATA.TYPE_ID; there is a one-to-many relationship 192 between KEYWORDBID_GROUPS.GROUP_ID and KEYWORDBID_GROUPS_DATA.GROUP_ID; and there is a one-to-many relationship 194 between KEYWORDBID.BID_ID and KEYWORDBID_GROUPS_DATA.BID_ID. Although the structure of database 22 allows for a search term to belong to more than one group, this is prevented at the user interface, which forces a user to remove a search term from one group before it is available for addition into another group, as can be understood from FIG. 9.

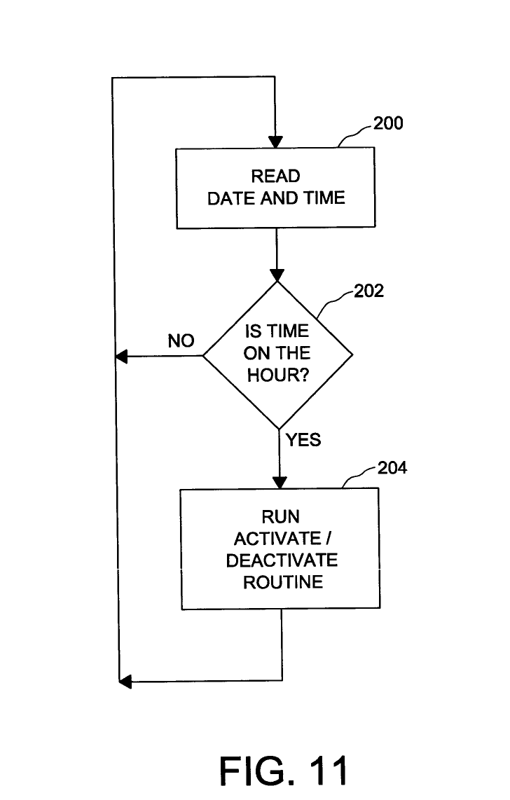

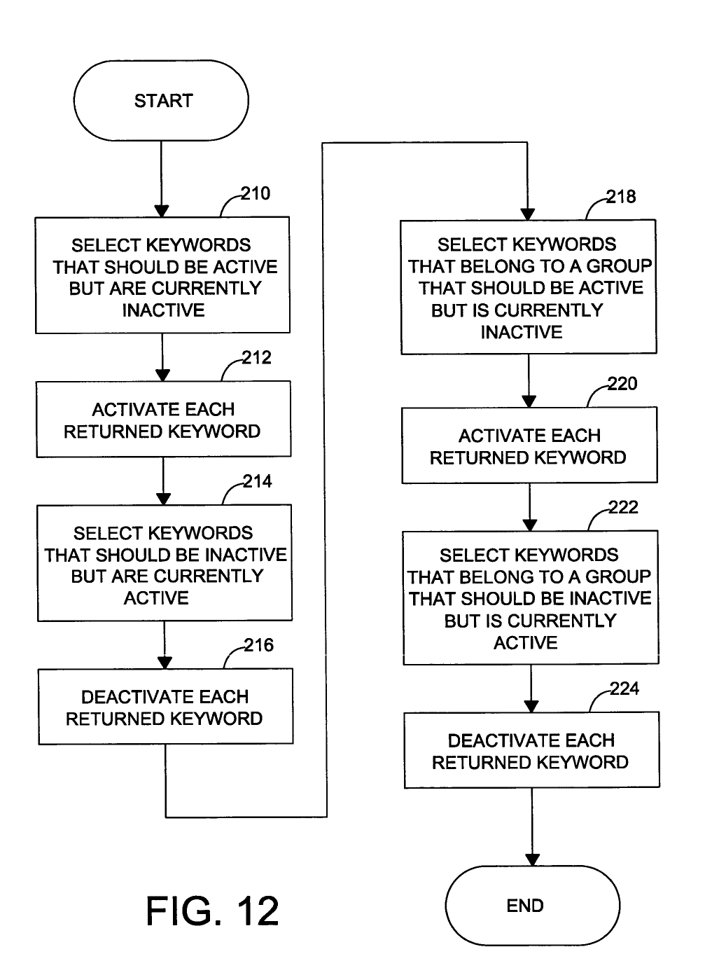

The scheme by which a search term, or group of search terms, is activated or deactivated will now be described with reference to the flow diagrams of FIGS. 11 and 12. FIG. 11 illustrates a basic monitoring routine of the present invention. Date and time information provided by a system clock are continually read under block 200 and evaluated under block 202 to determine if the time is “on the hour” (i.e. 12:00, 1:00, 2:00 etc.). If not, flow reverts to block 200 to read the next updated clock signal. If the time is “on the hour” then an activate/deactivate routine is run in accordance with block 204 before flow reverts back to read block 200. FIG. 12 illustrates an activate/deactivate routine of the present invention, which functions to include search terms in the search database of the search engine, and exclude search terms from the search database, as dictated by the scheduling data provided for the search term or for a group to which the search term belongs. First, pursuant to block 210, a select query is run which returns all individually scheduled search terms that should be active but are currently inactive. Each returned search term is then activated in accordance with block 212. Similarly, but in opposite fashion, a select query is run in block 214 to return all individually scheduled search terms that should be inactive but are currently active; the returned search terms are then deactivated in block 216. A similar process is followed in blocks 218, 220, 222, and 224 for all search terms belonging to a scheduled group. Search terms are preferably deactivated by changing the search term in accordance with some predetermined and reversible algorithm, such that the modified search term character string differs from the actual search term character string. In this way, an actual search term can be removed from the search database. If the search term is inactive, it is preferably activated by reversing the changes made by the algorithm to restore the original and actual search term character string, thereby returning the search term to the search database.

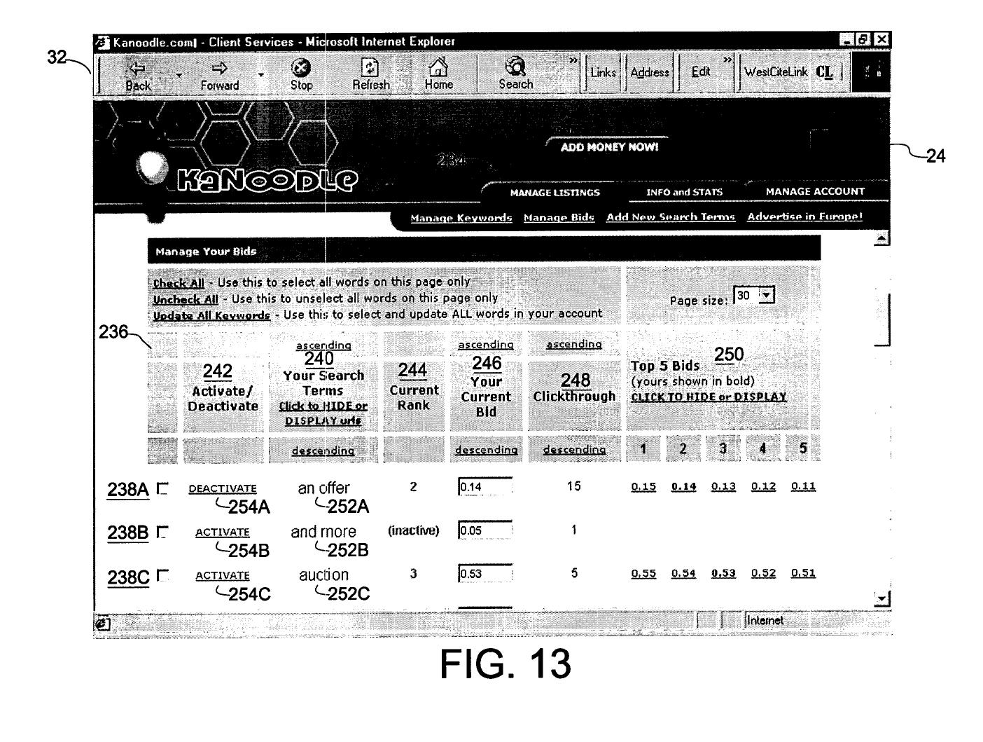

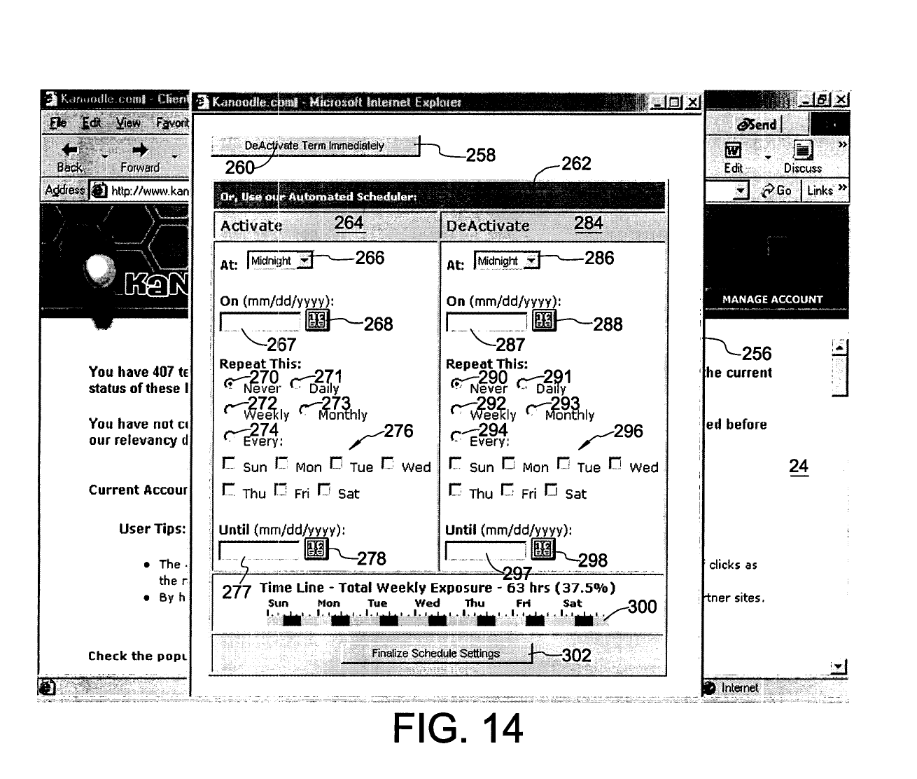

An alternative embodiment of the present invention will now be described with reference to FIGS. 13 and 14. Account management web page 24 includes a “manage listings” tab 234 by which a search term table 236 is displayed showing data records 238A-238C. Each data record relates to a respective search term listed in search term column 240 of table 236. More specifically, data record 238A includes search term 252A, namely “an offer”; data record 238B includes search term 252B, namely “and more”; and data record 238C includes search term 252C, namely “auction”. As indicated in the heading of column 240, each search term has one or more URLs associated therewith. An advertiser connected with the account can establish a portfolio of search terms and bid on each search term, whereby the bid amount determines the ordinal position of a link to the advertiser's web site (URL) in a list of links returned by search engine 12 in response to a user search request using the search term. Column 244 shows the bid rank and column 246 shows the bid amount for each search term. If the user clicks through to the advertiser's web site, the advertiser is charged the bid amount listed in column 246. Column 248 shows the number of “click throughs” to the advertiser's web site generated by the search term, while column 250 displays the top five bid amounts for the search term.

In accordance with the present invention, each individual search term has an associated activation property or field for registering an “activated” value or a “deactivated” value (the values can be registered in any suitable fashion, such as yes/no, true/false, 1/0, on/off, etc.). Column 242 of table 236 contains activation property toggle links 254A-254C respectively associated with search terms 252A-252C by which an advertiser can activate or deactivate a specific search term in its portfolio either manually or automatically at scheduled times. When an activation property or field associated with the search term is set to its activated value, the advertiser's URLs for that search term will be returned by the search engine in response to a corresponding search, and the advertiser must pay the bid amount if a user clicks through to the advertiser's web site. Conversely, when the activation property is set to its deactivated value, the advertiser's web site link is not included in the data set of searched records in search engine database 16 and thus will not be returned as a search result listing by search engine 12. FIG. 14 shows a pop-up search term scheduling form 256 of the present invention. Scheduling form 256 appears in response to a user clicking the associated activation property toggle link 254A (or 254B or 254C, etc.) for a particular search term 252A (or 252B or 252C, etc.). Scheduling form 256 includes a command button 258 having a label 260 implicitly indicating the current value of the activation property. In FIG. 14, label 260 reads “DeActivate Tern Immediately,” which indicates to the user that the term is currently activated. Clicking command button 258 executes an instruction to immediately change the value of the activation property, for example from Activated to Deactivated. When the value of the activation property is Deactivated, programming code changes the label 260 on command button 258 to read “Activate Term Immediately,” and clicking command button 258 executes an instruction to immediately change the value of the activation property from deactivated to activated. However, unless the scheduling data are removed, the manual instruction will eventually be overridden by the scheduling data at the next logical time when the value of the activation property is checked and found to be contrary to the schedule.

Scheduling form 256 further includes a scheduling panel 262 having an activate portion 264 and a deactivate portion 284. Activate portion 264 includes a combo box 266 for inputting a time of day with the aid of a selectable drop-down menu, a text box 267 for inputting a start date with the aid of a selectable calendar control 268, and a another text box 277 for inputting an end date with the aid of a selectable calendar control 278. Likewise, deactivate portion 284 includes a combo box 286 for inputting a time of day with the aid of a selectable drop down menu, a text box 287 for inputting a start date with the aid of a selectable calendar control 288, and a another text box 297 for inputting an end date with the aid of a selectable calendar control 298. Activate portion 264 and deactivate portion 284 also have respective means for inputting a repeat interval. In activate portion 264, a set of option buttons are provided for choosing a repeat interval, including a “Never” option button 270, a “Daily” option button 271, a “Weekly” option button 272, a “Monthly” option button 273, and an “Every:” option button 274. The “Every:” option button refers to seven check boxes 276 corresponding to the days of the week. Deactivate portion 284 includes a “Never” option button 290, a “Daily” option button 291, a “Weekly” option button 292, a “Monthly” option button 293, and an “Every:” option button 294 referring to day-of-the-week check boxes 296.

Activate portion 264 and deactivate portion 284 of scheduling panel 262 enable an advertiser to schedule the times when a search term will be activated and deactivated automatically. By way of illustrative example, an advertiser selling office supplies on-line might wish to activate the search term “office supplies” Monday through Friday from 9:00 AM to 8:00 PM Eastern Standard Time for the period from Jan. 1, 2004 until Feb. 1, 2004, and to deactivate the search term at all other times during this period. To do this, the advertiser would enter “9:00 AM” in combo box 266, enter Jan. 1, 2004 in text box 267, choose the “Every:” option button 274, select check boxes 276 for Monday, Tuesday, Wednesday, Thursday, and Friday, and enter Feb. 1, 2004 in text box 277. The advertiser would further enter “8:00 PM” in combo box 286, enter Jan. 1, 2004 in text box 287, choose the “Every:” option button 294, select check boxes 296 for Monday, Tuesday, Wednesday, Thursday, and Friday, and enter Feb. 1, 2004 in text box 297. The scheduling data inputted by the advertiser in activate portion 264 serve as a basis to define date and time conditions that, when met, cause a programming instruction to be executed setting the activation property to an activated value. Similarly, the scheduling data inputted by the advertiser in deactivate portion 284 serve as a basis to define date and time conditions that, when met, cause a programming instruction to be executed setting the activation property to a deactivated value.

The scheduling data entered in the activate and deactivate portions 264 and 284 are preferably used to create a graphic schedule 300 indicating when the activation property of the search term is scheduled to have an activated value and when it is scheduled to have a deactivated value. In FIG. 14, graphic schedule 300 is in the form of a weekly exposure time line, however other forms are possible depending upon the scheduling data. For example, a monthly calendar graphic or a daily time block graphic could be provided. A “Finalize Schedule Settings” command button 302 is provided, which the advertiser clicks to execute a command that enters the scheduling data for use by the programming code.

As will be appreciated from the foregoing description, the method and system of the present invention provide a convenient way for advertisers to maximize ROI and control their investment in each individual search term. Moreover, benefits of the invention can be realized with existing hardware and relatively simple programming code.

1. A method for scheduling a search term in a search engine advertiser account for intermittent use by a search engine, said method comprising the steps of:
receiving a user instruction indicating at least one activated period when said search term is to be included in a database searched by said search engine and at least one deactivated period when said search term is to be excluded from said database;
including said search term in said database during said at least one activated period and excluding said search term from said database during said at least one deactivated period.

2. The method according to claim 1, wherein said user instruction is received via an information network.

3. The method according to claim 1, wherein said user instruction calls for immediately commencing an activated period if said search term is in a deactivated period, or immediately commencing a deactivated period if said search term is in an activated period.

4. The method according to claim 1, wherein said at least one activated period commences at a future time.

5. The method according to claim 1, wherein said at least one deactivated period commences at a future time.

6. The method according to claim 4, wherein said at least one activated period is a plurality of activated periods.

7. The method according to claim 5, wherein said at least one deactivated period is a plurality of deactivated periods.

8. The method according to claim 1, further comprising the step of transmitting a scheduling form for use in defining said user instruction.

9. The method according to claim 8, wherein said scheduling form includes means for inputting a time of day and days of the week defining said at least one activated period.

10. The method according to claim 8, wherein said scheduling form includes means for inputting a start date and an end date associated with said user instruction.

11. The method according to claim 9, wherein said scheduling form includes means for inputting a start date and an end date associated with said user instruction.

12. The method according to claim 8, wherein said scheduling form includes a graphic schedule indicating said at least one activated period and said at least one deactivated period.

13. The method according to claim 1, wherein said search term is excluded from said database by modifying said search term in said advertiser account according to a predetermined algorithm.

14. The method according to claim 1, wherein said user instruction comprises scheduling data for defining said at least one activated period and said at least one deactivated period.

15. A system for scheduling a search term in a search engine advertiser account for intermittent use by a search engine, said system comprising:
a computer system having stored thereon
an account database for recording said search term and scheduling data related to said search term;
programming code for providing a user interface allowing a user to input said scheduling data; and
programming code for including said search term in a search database accessed by said search engine, and for excluding said search term from said search database, based on said scheduling data.

16. The system according to claim 15, wherein said scheduling data are inputted via an information network.

17. The system according to claim 16, wherein said scheduling data include a starting time of day, an ending time of day, and at least one day of the week for defining when said search term is to be included in said search database.

18. The system according to claim 17, wherein said scheduling data include a start date and an end date associated with said starting time of day, said ending time of day, and said at least one day of the week.

19. The system according to claim 15, wherein said user interface is a scheduling form transmitted to the user via an information network.

20. The system according to claim 19, wherein said scheduling form includes a graphic schedule indicating when said search term is to be included in said search database and when said search term is to be excluded from said search database.

21. The system according to claim 15, wherein said user interface includes means for a user to enter a command to immediately override said scheduling data.

22. A method for scheduling a plurality of search terms in a search engine advertiser account for intermittent use by a search engine, said method comprising the steps of:
receiving a group identifier from a user;
linking selected search terms in said search engine advertiser account with said group identifier to define a group of search terms;
receiving a user instruction indicating at least one activated period when said search terms in said group are to be included in a database searched by said search engine and at least one deactivated period when said search terms in said group are to be excluded from said database;
including said group of search terms in said database during said at least one activated period and excluding said group of search terms from said database during said at least one deactivated period.

23. The method according to claim 22, wherein said group identifier is received via an information network.

24. The method according to claim 22, wherein said selected search terms are selected by said user via an information network.

25. A system for scheduling a plurality of search terms in a search engine advertiser account for intermittent use by a search engine, said system comprising:
a computer system having stored thereon
an account database for recording a group identifier, selected search terms linked with said group identifier, and scheduling data related to said group;
programming code for providing a user interface allowing a user to input said scheduling data; and
programming code for including said linked search terms in a search database accessed by said search engine, and for excluding said linked search terms from said search database, based on said scheduling data.

26. The system according to claim 25, wherein said user interface allows said user to input said scheduling data via an information network.

27. The system according to claim 25, wherein said computer system further has stored thereon programming code for providing a user menu allowing a user to select search terms to be linked to said group identifier.

28. The system according to claim 27, wherein said user menu allows said user to select search terms via an information network.
